(19) United States
(12) Patent Application Publication
(10) Pub. No.: US 2014/0172420 A1
(43) Pub. Date: Jun. 19, 2014

(54) AUDIO OR VOICE SIGNAL PROCESSOR

(71) Applicant: Huawei Technologies Co., Ltd., Shenzhen (CN)

(72) Inventors: Anisse Taleb, Stockholm (SE); Jianfeng Xu, Shenzhen (CN); Liyun Pang, Shenzhen (CN); Lei Miao, Beijing (CN)

(73) Assignee: Huawei Technologies Co., Ltd., Shenzhen (CN)

(21) Appl. No.: 14/187,523

(22) Filed: Feb. 24, 2014

Related U.S. Application Data
(63) Continuation of application No. PCT/CN2011/078868, filed on Aug. 24, 2011.

(51) Int. Cl. G10L 21/0224

(52) U.S. Cl. CPC G10L 21/0224
USPC 704/211

(57) ABSTRACT

A voice or audio signal processor for processing received network packets received over a communication network to provide an output signal, the voice or audio signal processor comprising a jitter buffer being configured to buffer the received network packets, a voice or audio decoder being configured to decode the received network packets as buffered by the jitter buffer to obtain a decoded voice or audio signal, a controllable time scaler being configured to amend a length of the decoded voice or audio signal to obtain a time scaled voice or audio signal as the output voice or audio signal, and an adaptation control means being configured to control an operation of the time scaler in dependency on a processing complexity measure.

### CROSS-REFERENCE TO RELATED APPLICATIONS

This application is a continuation of International Application No. PCT/CN2011/078868, filed on Aug. 24, 2011 which is hereby incorporated by reference in its entirety.

### TECHNICAL FIELD

The present disclosure relates to an audio or voice processor with a jitter buffer.

### BACKGROUND

Packet-switched networks (such as local area networks (LANs) or the Internet) can be used to carry voice, audio, video or other continuous signals, such as Internet telephony or audio/video conferencing signals and audiovisual streaming such as IPTV. In such applications, a sender and a receiver typically communicate with each other according to a protocol, such as the Real-time Transport Protocol (RTP), which is described in RFC 3550. Typically, the sender digitizes the continuous input signal, such as by sampling the signal at fixed or variable intervals. The sender sends a series of packets over the network to the receiver. Each packet contains data representing one or more discrete signal samples. Typically the sender sends, i.e. encodes, the packets at regular time intervals. The receiver reconstructs, i.e. decodes, the continuous signal from the received samples and typically outputs the reconstructed signal, such as through a speaker or on a screen of a computer.

However, complexity of an encoder or decoder is an important issue for some mobile devices that have less computing ability compared to powerful desktop computers and other advanced devices. For example the complexity of a decoder without time scaling for a given frame is defined as the number of operations per frame length where frame length is the duration of the frame, for example, 20 ms.

Thus, increasing complexity and complexity overload lead to the problem of noise and artifacts in media signals, such as voice, audio or video signals.

### SUMMARY

One object of the present disclosure is to reduce delay jitter encountered by voice or audio signals over network.

This object is achieved by the features of the independent claims. Further implementation forms are apparent from the dependent claims, the description and the figures.

According to a first aspect, the present disclosure relates to a voice or audio signal processor for processing received network packets received over a communication network to provide an output signal, the voice or audio signal processor comprising: a jitter buffer being configured to buffer the received network packets; a voice or audio decoder being configured to decode the received network packets as buffered by the jitter buffer to obtain a decoded voice or audio signal; a controllable time scaler being configured to amend a length of the decoded voice or audio signal to obtain a time scaled voice or audio signal as the output voice or audio signal; and an adaptation control means being configured to control an operation of the time scaler in dependency on a processing complexity measure.

In a first possible implementation form of the voice or audio signal processor according to the first aspect, the adaptation control means is configured to transmit a time scaling request indicating to amend the length of the decoded voice or audio signal in dependency on the processing complexity measure in order to control the controllable time scaler.

In a second possible implementation form of the voice or audio signal processor according to the first aspect as such or according to the first implementation form of the first aspect, the adaptation control means is configured to determine a number of samples by which to amend the length of the decoded voice or audio signal upon the basis of the processing complexity measure, and to transmit a time scaling request to the controllable time scaler, and wherein the controllable time scaler is configured to amend the length of the decoded voice or audio signal by the determined number of samples.

In a third possible implementation form of the voice or audio signal processor according to the first aspect as such or according to any of the preceding implementation forms of the first aspect, the processing complexity measure is determined by at least one of: complexity of decoding, a length of the time scaled voice or audio signal frame, bitrate, sampling rate, delay mode indicating e.g. a high delay or a low delay.

In a fourth possible implementation form of the voice or audio signal processor according to the first aspect as such or according to any of the preceding implementation forms of the first aspect, the voice or audio signal processor comprises a storage for storing different processing complexity measures for different decoded audio signal lengths.

In a fifth possible implementation form of the voice or audio signal processor according to the first aspect as such or according to any of the preceding implementation forms of the first aspect, the audio decoder is configured to provide the processing complexity measure to the adaptation control means.

In a sixth possible implementation form of the voice or audio signal processor according to the first aspect as such or according to any of the preceding implementation forms of the first aspect, the adaptation control means is further configured to control the operation of the controllable time scaler in dependency on a jitter buffer status.

In a seventh possible implementation form of the voice or audio signal processor according the sixth implementation form, the jitter buffer is configured to provide the jitter buffer status to the adaptation control means.

In an eighth possible implementation form of the voice or audio signal processor according to the first aspect as such or according to any of the preceding implementation forms of the first aspect, the adaptation control means is further configured to control the operation of the controllable time scaler in dependency on a network packet arrival rate.

In a ninth possible implementation form of the voice or audio signal processor according to the first aspect as such or according to any of the preceding implementation forms of the first aspect, the voice or audio signal processor further comprises a network rate determiner for determining a packet rate of the network packets, and to provide the packet rate to the adaptation control means.

In a tenth possible implementation form of the voice or audio signal processor according to the first aspect as such or according to any of the preceding implementation forms of the first aspect, the controllable time scaler is configured to amend the length of the decoded voice or audio signal by a number of samples.

In an eleventh possible implementation form of the voice or audio signal processor according to the first aspect as such or according to any of the preceding implementation forms of the first aspect, the controllable time scaler is configured to overlap and add portions of the decoded voice or audio signal for time scaling.

In an twelfth possible implementation form of the voice or audio signal processor according to the first aspect as such or according to any of the preceding implementation forms of the first aspect, the controllable time scaler is configured to provide a time scaling feedback to the adaptation control means, the time scaling feedback informing the adaptation control means of the length of the time scaled voice or audio signal.

According to a second aspect, the present disclosure relates to a method for processing received network packets over a communication network to provide an output signal, the method comprising buffering the received network packets, decoding the received packets as buffered to obtain a decoded voice or audio signal, controllably amending a length of the decoded voice or audio signal to obtain a time scaled voice or audio signal as the output voice or audio signal in dependency on a processing complexity measure.

According to a second aspect, the present disclosure relates to a computer program for performing the method according to the second aspect, when run on a computer.

### BRIEF DESCRIPTION OF THE DRAWINGS

Further embodiments are described with respect to the figures, in which:

FIG. 1 shows a constant stream of packets at a sender side leading to an irregular stream of packets in the receiving side due to delay jitter;

FIG. 2 shows a jitter buffer receiving packetized speech over a network and forwarding the packets to a play back device;

FIG. 3 shows an adaptive jitter buffer management with media adaptation unit;

FIG. 4 shows a jitter buffer management with time scaling based on pitch;

FIG. 5 shows a jitter buffer management with time scaling based on frequency domain processing;

FIG. 6 shows a jitter buffer management with time scaling based on pitch and SID-flag;

FIG. 7 shows a jitter buffer management based on complexity evaluation;

FIG. 8 shows a jitter buffer management based on complexity evaluation in which external complexity information is considered;

FIG. 9 shows a jitter buffer management based on complexity evaluation and time scaling with pitch information;

FIG. 10 shows a jitter buffer management based on complexity evaluation and time scaling in frequency domain;

FIG. 11 shows a jitter buffer management based on complexity evaluation, SID-flag and time scaling with pitch information; and

FIG. 12 shows a jitter buffer management based on complexity evaluation and an external control parameter.

### DETAILED DESCRIPTION

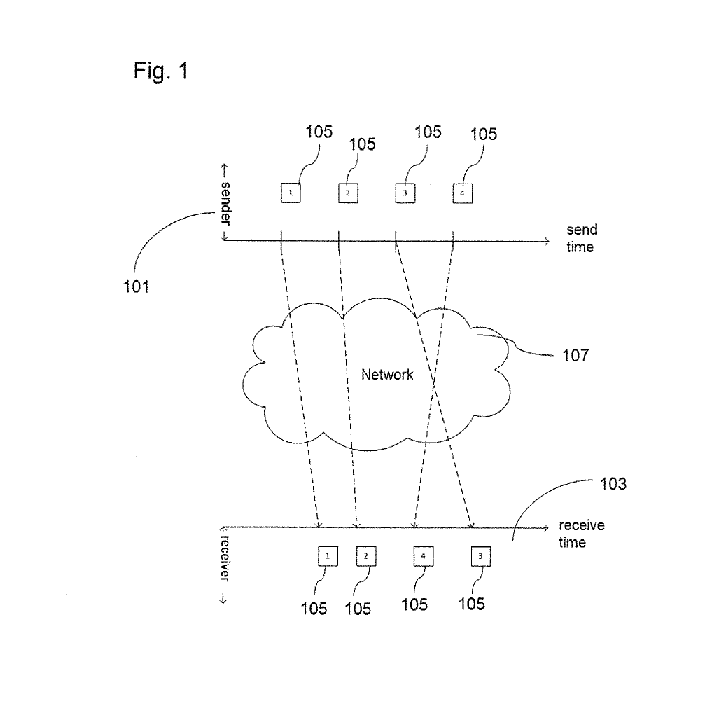

FIG. 1 shows a sender 101 sending packets 105 to a receiver 103. Normally, the sender 101 uses an encoder to compress samples before sending the packets 105 to the receiver 103. This allows reducing the amount of data to be transmitted and the effort and resources required for transmission. Depending on the type of media to be transmitted, e.g. voice, audio or video, different encoders are used to compress data and to reduce the size of the content to be transmitted over the packet network 107. Examples of voice encoders are AMR, AMR-WB; examples of encoders for generic audio signals and music are MP3 or AAC family; and examples encoders for video signals are H.263 or H.264/AVC. The receiver 103 uses a corresponding compatible decoder to decompress the samples before reconstructing the signal.

Senders 101 and receivers 103 use clocks to govern the rates at which they process data. However these clocks are typically not synchronized with each other and may operate at different speeds. This difference can cause a sender 101 to send packets 105 too frequently or not frequently enough as seen from the receiver side 103, thereby causing the buffer of the receiver 103 either to overflow or underfloor.

Furthermore, the Internet and most other packet networks, over which real-time packets are sent; cause variable and unpredictable propagation delays which mainly arise due to network congestion, improper queuing, or configuration errors. As a consequence packets 105 arrive at the receiver 103 with variable and usually unpredictable inter-arrival time. This phenomenon is called “jitter” or “delay-jitter”.

FIG. 1 gives an illustration of this effect. Packets 1, 2, 3 and 4 are sequentially transmitted at the sender side 101 at regular intervals. Jitter in the network 107 makes the packets 1, 2, 3 and 4 arrive in different intervals and usually out of order at the receiver side 103.

A jitter buffer is a shared data area in which the received packets 105 can be collected, stored, and forwarded to the decoder at evenly spaced intervals. Thus, the jitter buffer located at the receiving end can be seen as an elastic storage area for compensating for the delay jitter and providing at its output a constant stream of packets to the decoder in correct order.

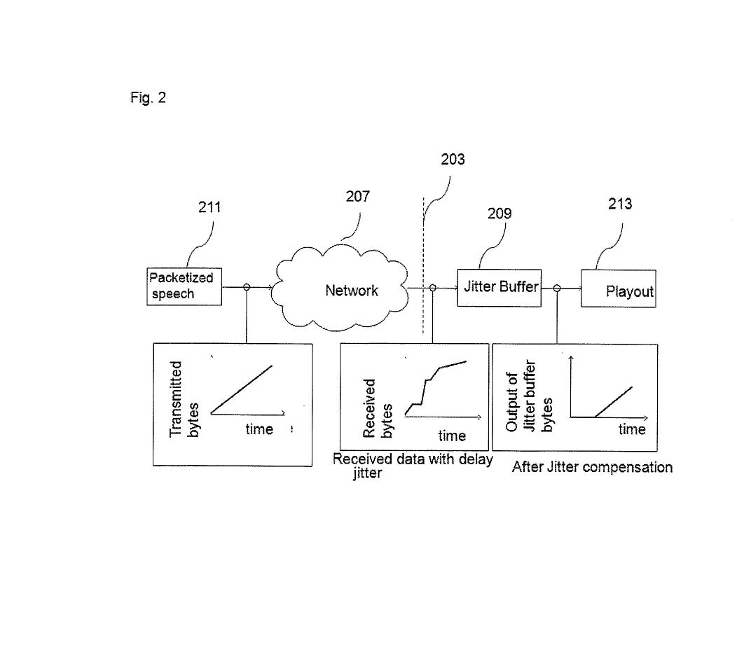

FIG. 2 shows a jitter buffer 209 receiving packetized speech 211 over a network 207 and forwarding the packets to a play back device 213. In order to properly reconstruct voice packets at the receiver 203, the jitter buffer 209 absorbs delay variations and supplies the decoder with a regular stream of packets.

In particular, FIG. 2 shows the case of a speech codec operated at constant bitrate. In the course of time the number of transmitted bytes increases linearly. However, at the receiving side 203 packets are received at irregular time intervals and the received bytes vary in a nonlinear and discontinuous fashion over time.

The jitter buffer 209 compensates for this irregularity and provides at its output a regular stream of packets, albeit at a delay. Once the jitter buffer 209 contains some packets 105, it begins supplying the packets to the decoder at a fixed rate.

Generally, the jitter buffer 209 enables continuously supplying packets to the at the fixed rate, even if packets from the sender arrive at the jitter buffer 209 at a variable rate or even if no packets arrive for a short period of time.

However, if an insufficient number of packets arrive at the jitter buffer 209 for an extended period of time, e.g. when the network is congested, the jitter buffer 209 may run low and a so-called underflow occurs. An empty jitter buffer 209 is not able to provide packets to the decoder. This causes an undesirable gap in the ideally continuous signal output by the receiver 203 until a further packet arrives. Such a gap will be considered by the decoder as a packet loss and depending on the manner the decoder handles packet losses, which is called the packet loss concealment, either silence for example in a voice or audio signal or a blank or “frozen” screen in a video signal appears. In general this is an undesirable situation since the perceived quality will be negatively impacted.

However, if too many packets arrive at the jitter buffer 209 over a short period of time than the jitter buffer 209 can accommodate, e.g. when a congested network suddenly becomes less busy, the jitter buffer 209 can overflow and is forced to discard some of the arriving packets. This causes a loss of one or more packets.

A so-called adaptive jitter buffer management can increase or decrease the number of samples, depending on the arrival rate of the packets. Although an adaptive jitter buffer is less likely to overflow than a fixed-size jitter buffer, an adaptive jitter buffer can experience underflow and cause the above-described gaps in the signal output by the receiver. To increase or decrease the number of samples, a media adaptation unit is to be applied to the decoded signal.

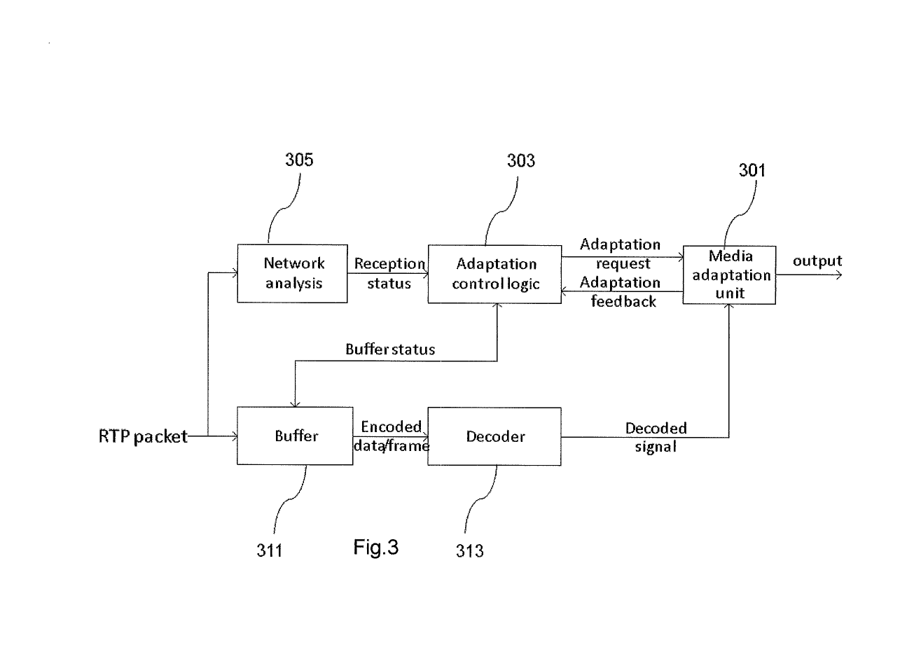

FIG. 3 shows an adaptive jitter buffer management with media adaptation unit 301.

In some cases the media adaptation unit 301 cannot change the number of samples or change the exact number as the adaptation logic 303 requests the media adaptation unit, for example each one-pitch period or integral times of pitch period will be changed to keep the good quality of service.

An RTP-packet is a packet with an RTP-payload and RTP-header. In the RTP-payload, there is a payload header and payload data (encoded data). Network analysis 305 will analyze the network condition based on RTP header information and get the reception status. The jitter buffer 311 stores encoded data/frames. The decoder 313 decodes the encoded data in order to restore the decoded signal. The adaptation control logic 303 analyzes the reception status and maintains the jitter buffer 311 and finally determines whether to request a time scaling on the decoded signal. In addition there could be a pitch determination module which determines the pitch of the decoded signal. This pitch information is used in the time scaling module to obtain the final output.

The jitter buffer 311 unpacks incoming RTP-packets and stores received speech frames. The buffer status may be used as input to the adaptation control logic 303. Furthermore, the jitter buffer 311 is also linked to the speech decoder 313 to provide frames for decoding when requested.

The network analysis 305 is used to monitor the incoming packet stream and to collect reception statistics, e.g. jitter or packet loss, that are needed for a jitter buffer adaptation.

The adaptation control logic 303 adjusts playback delay and controls the adaptation functionality. Based on the buffer status, e.g. average buffering delay, buffer occupancy, and input from the network analysis 305, it makes decisions on the buffering delay adjustments and required media adaptation actions. The adaptation control logic 303 then sends the adaptation request, such as the expected frame length, to the media adaptation unit 301.

The decoder 313 will decompress the encoded data into decoded signals for replaying.

The media adaptation unit 301 shortens or extends the output signal length according to requests given by the adaptation control logic 303 to enable buffer delay adjustment in a transparent manner. In some cases the adaptation request from adaptation control logic 303 cannot be fulfilled. For example, the media adaptation unit 303 cannot change the signal length or the length can only be added or removed in units of pitch periods to avoid artifacts. This kind of feedback information, such as the actual resulting frame length, is sent to the adaptation control logic 303.

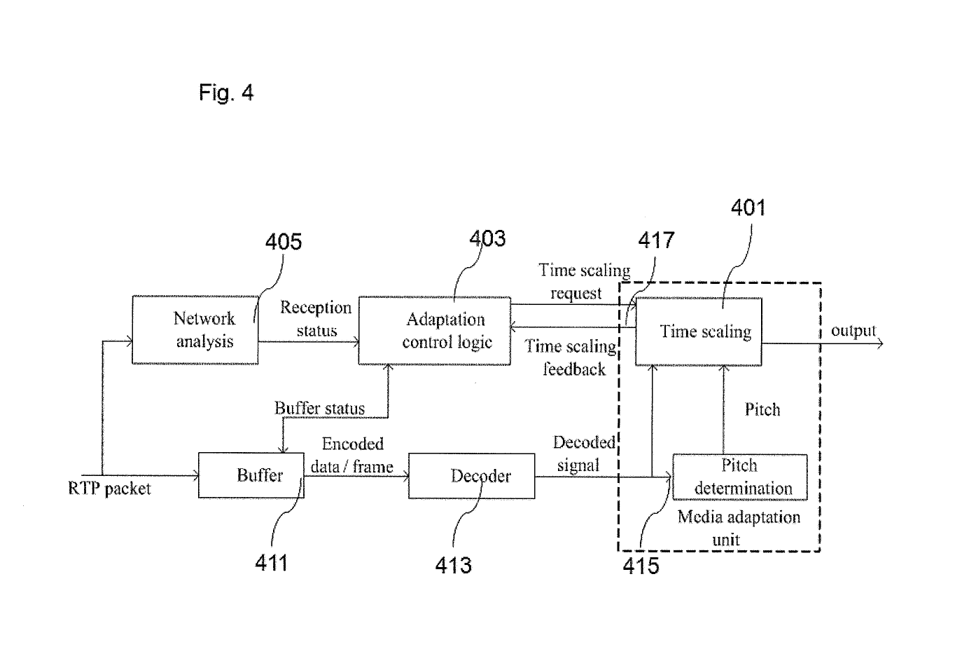

FIG. 4 shows a jitter buffer management with time scaling based on pitch. The jitter buffer management implementation comprises a media adaptation unit 401, an adaptation control logic 403, a network analysis 405, a jitter buffer 411, a decoder 413, a pitch determination unit 415 and a time-scaling unit 417.

Since pitch is an important property of human voice, many jitter buffer management (JBM) implementations use pitch-based time scaling technology to increase or decrease the number of samples. The time scaling is based on the pitch information.

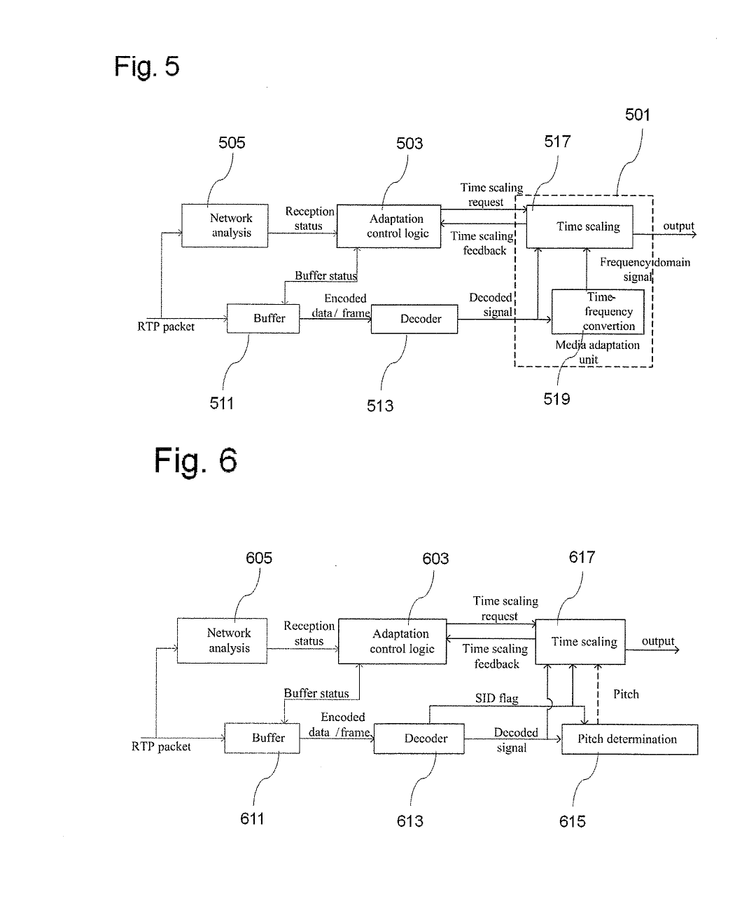

FIG. 5 shows a jitter buffer management with time scaling based on frequency domain processing. The jitter buffer management implementation comprises a media adaptation unit 501, an adaptation control logic 503, a network analysis 505, a jitter buffer 511, a decoder 513, a time scaling unit 517 and a time frequency conversion unit 519.

For generic audio signals, the pitch information is often not important or not available. Therefore, time scaling or in general processing by the media adaptation unit 501 cannot be based on pitch information, but instead on generic frequency domain time scaling, for instance using fast Fourier transform (FFT) or MDCT (Modified discrete cosine transform). In this case, time-frequency conversion by a time-frequency conversion unit 519 is needed before time scaling.

FIG. 6 shows a jitter buffer management with time scaling based on pitch and SID-flag. The jitter buffer management implementation includes an adaptation control logic 603, a network analysis 605, a jitter buffer 611, a decoder 613, a time scaling unit 617 and a pitch determination unit 615.

Some encoders have a voice activity detection module (VAD-module). The VAD-module classifies a signal as silence or non-silence. A silence signal will be encoded as a silence insertion descriptor packet/frame (SID packet/frame). Pitch information is not important for a silence signal. However, the decoder determines whether the frame is silence or not due to the SID-flag in the encoded data. If the frame is an SID-frame, pitch search is not necessary and the time scaling module can increase or decrease the number of samples directly for the silence signal.

The complexity of encoder or decoder is an important issue for some mobile devices which have less computing ability compared to powerful desktop computer and other advanced devices.

The complexity of decoder without time scaling for a given frame is defined as:

$${Comp}_{woTS} ( i ) = \frac{numberOfOperation ( i )}{frame\_length} \qquad ( 1 )$$

where frame_length is the duration of a frame (for example, 20 ms), numberOfOperations(i) is the number of operations of the given frame, and i is the index of a given frame.

The complexity of a decoder without time scaling can be determined from a preset table according to the specific coding mode or input/out sampling rate. A preset table allows an easy implementation to get an approximate estimation of the complexity for decoding a frame and is similar in principle to a lookup table. The complexity as described in equation (1) relates to the number of operation per second, which accurately represents the actual CPU-load when running the decoder.

When the aforementioned time scaling is used for jitter buffer management, the actual frame length of the output signal will be changed, which results in a different equation.

Increasing the number of samples, i.e. stretching the signal, means that the decoder will decode frames less frequently and frames are consumed from the jitter buffer at a lower frequency. Decoding frame less frequently means that the complexity of the decoder is reduced in terms of operations per second, since fewer frames need to be decoded during a certain time period.

Decreasing the number of samples, i.e. compressing the signal, means that the decoder will decode frames more frequently and frames are consumed from the jitter buffer at a higher frequency. A more frequent decoding of frames means that the complexity of the decoder is increased in terms of operations per second, since more frames need to be decoded during a certain time period.

The complexity equation for decoder with time scaling will be

$$\begin{matrix}{Comp}_{wTS} ( i ) = \frac{numberOfOperations ( i )}{frame\_length} * \frac{normalNumberOfSamples ( i )}{producedNumberOfSamples ( i )} \\ = {Comp}_{woTS} ( i ) * \frac{normalNumberOfSamples ( i )}{producedNumberOfSamples ( i )}\end{matrix} \qquad ( 2 )$$

where normalNumberOfSamples(i) is the number of samples that the decoder would have produced and could be obtained from the decoder for the given frame, if time scaling weren't be used, and producedNumberOfSamples(i) is the number of samples that the decoder produces for the given frame, after time scaling has been applied.

Since the complexity equation (1) does not take into account the complexity of the time scaling itself, which could be dependent on a time-scaling-request-parameter, the relationship is not really linear. But since normally the complexity of time-scaling is much smaller than the decoder complexity, the relationship is very close to being linear.

In many applications computational complexity is a major factor, which has to be taken into account, in order to ensure good performance and correct platform dimensioning. In mobile applications, for instance, computational complexity has a direct impact on battery lifetime. Even for plugged network elements, such as a telephone bridge, the number of maximum channels, i.e. users, that the hardware could support is directly related to the worst case CPU load. It is therefore a general challenge to limit the maximum complexity. In general, an increased complexity will drive power consumption of every device. This is an undesirable effect especially in today's ongoing efforts for a better environment and energy efficiency.

Therefore, Comp_{wTS} should be less than a maximum allowable complexity, since otherwise the load on the CPU cannot be controlled and leads to undesirable effects such as a loss of synchronicity, which then again would lead in the case of voice or audio signals to annoying clicks in the perceived quality. This present disclosure circumvents the above mentioned drawbacks by taking complexity into account and therefore avoiding situations where the CPU is overloaded.

To avoid the problem of complexity overload, the present disclosure will take the complexity information into account before sending the time scaling request. For example it could be checked with the time scaling, in order that the total complexity will not exceed the computing ability of the device or hardware.

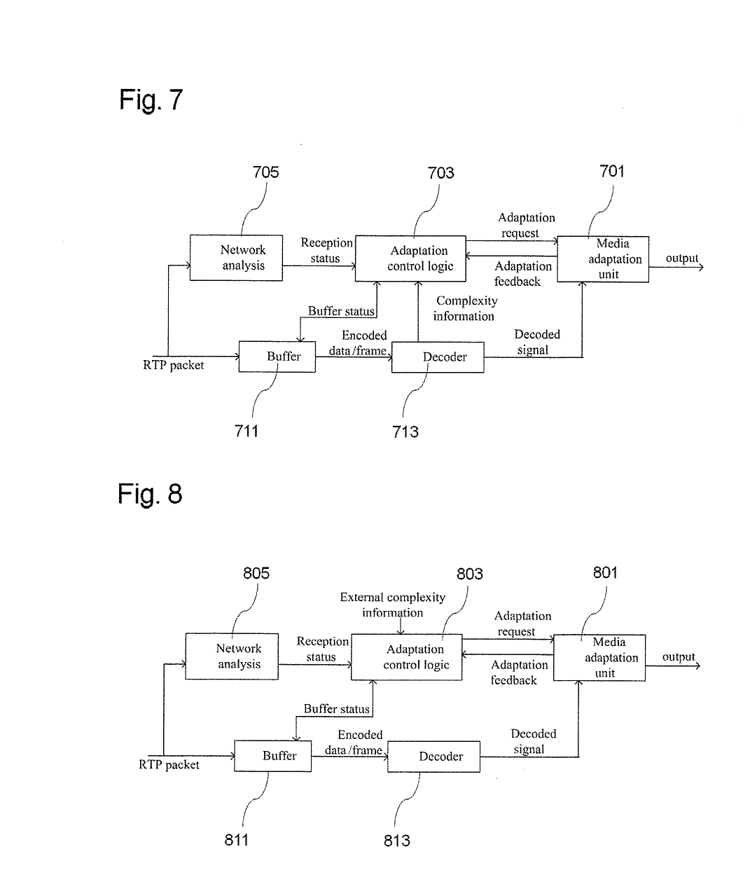

FIG. 7 shows a jitter buffer management based on complexity evaluation. The jitter buffer management implementation includes a media adaptation unit 701, an adaptation control logic 703, a network analysis 705, a jitter buffer 711, a decoder 713.

FIG. 8 shows a jitter buffer management based on complexity evaluation in which external complexity information is considered. The jitter buffer management implementation includes a media adaptation unit 801, an adaptation control logic 803, a network analysis 805, a jitter buffer 811 and a decoder 813.

The complexity control can also be an external control. For example, the remaining battery power of the hardware could be taken into account for a complexity control, e.g. of a mobile phone, tablet, PC.

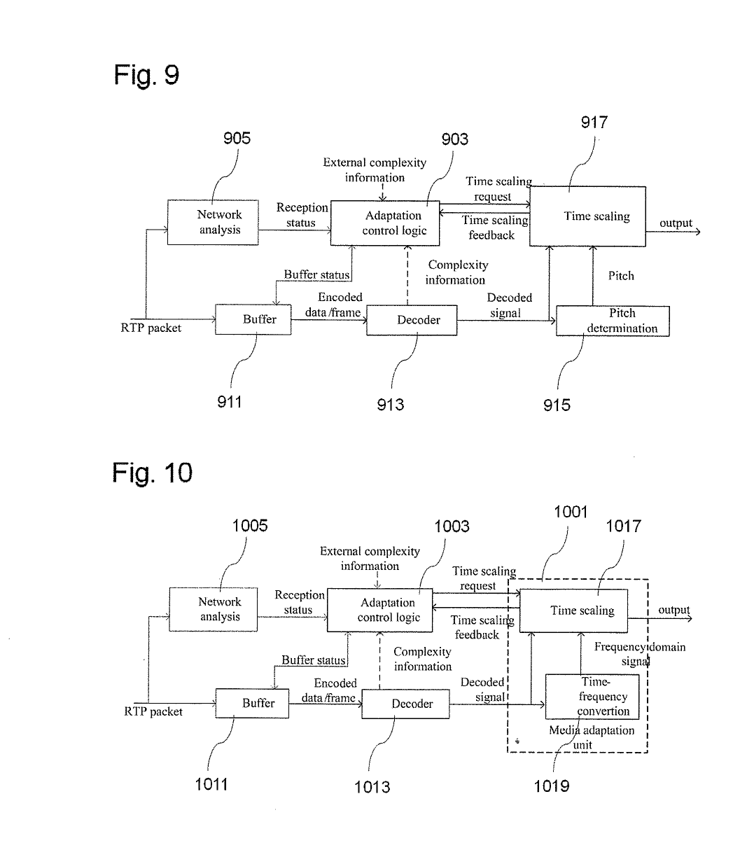

FIG. 9 shows jitter buffer management based on complexity evaluation and time scaling with pitch information. The jitter buffer management implementation includes an adaptation control logic 903, a network analysis 905, a jitter buffer 911, a decoder 913, a pitch determination unit 915 and a time scaling unit 917.

FIG. 10 shows a jitter buffer management based on complexity evaluation and time scaling in frequency domain. The jitter buffer management implementation includes a media adaptation unit 1001, an adaptation control logic 1003, a network analysis 1005, a jitter buffer 1011, a decoder 1013, a time scaling unit 1017 and a time frequency conversion unit 1019.

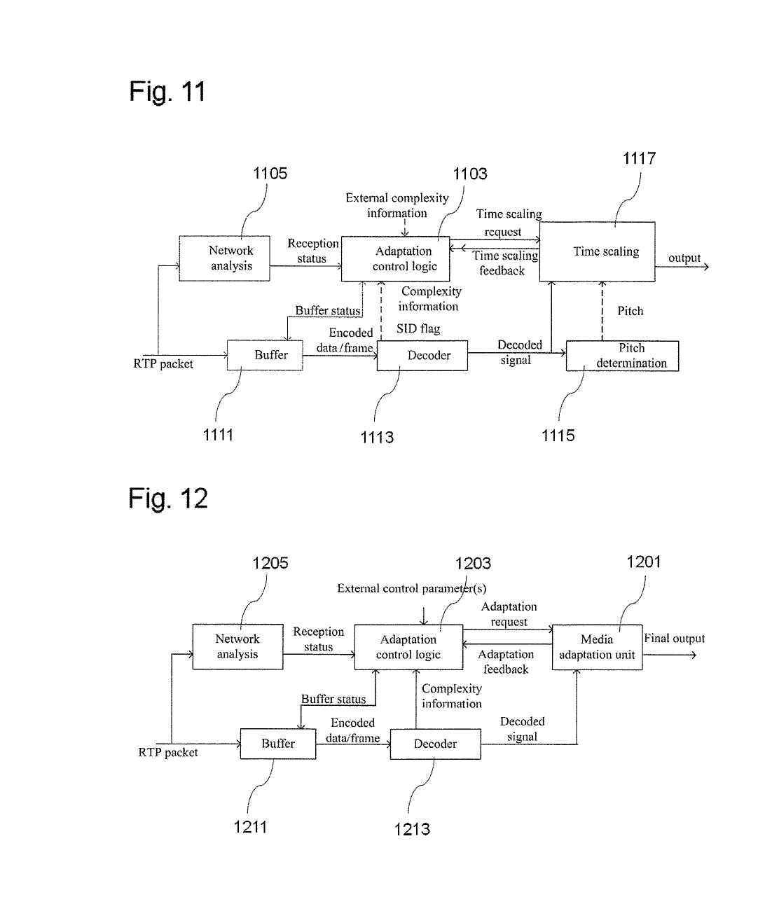

FIG. 11 shows jitter buffer management based on complexity evaluation, SID-flag and time scaling with pitch information. The jitter buffer management implementation includes an adaptation control logic 1103, a network analysis 1105, a jitter buffer 1111, a decoder 1113, a pitch determination unit 1115 and a time scaling unit 1117.

If VAD is activated in the encoder, the encoded data include a SID-flag. For SID-frames the complexity of decoder is much lower than for normal frames, and computing the pitch is not necessary. In this case complexity evaluation is not necessary for SID-frames. For normal frames, however, the complexity evaluation could be executed to avoid the complexity overload.

If the given frame is not a silence frame (SID-frame), an example for complexity evaluation is as follows:

Determining a complexity parameter cp, which could depend on the coding mode, such as sampling rate, bitrate or delay mode, or could be a constant.

For example, the cp can be a constant, i.e., cp=cp_const where cp_const is a constant value, such as the maximum acceptable complexity of the device or hardware.

If the cp depends on sampling rate, bitrate, delay mode,

cp=cp_function(sampling_rate, bitrate, delay_mode),

where cp_function is a function to get the value of cp.

If the cp depends on sampling rate and bitrate, then

cp=cp_function(sampling_rate,bitrate).

If the cp depends on sampling rate, then

cp=cp_function(sampling_rate).

If the cp depends on bitrate rate, then

cp=cp_function(bitrate_rate).

If the cp depends on delay_mode, for example, high delay or low delay, then

cp=cp_function(delay_mode).

However, cp could also depend on other codec parameters or other groups of codec parameters.

2. For packet following equation has to be fulfilled, if the complexity with time scaling is taken into account:

$$\begin{matrix}{Comp}_{wTS} ( i ) = {Comp}_{woTS} * \frac{normalNumberOfSamples ( i )}{producedNumberOfSamples ( i )} \\ = ( {dec\_Comp}_{woTS} ( i ) + {jbm\_Comp}_{woTS} ( i ) ) * \\ \frac{normalNumberOfSamples ( i )}{producedNumberOfSamples ( i )} \\ \leq cp\end{matrix}$$

where dec_Comp_{woTS}(i) is the complexity of decoder without jitter buffer management that could be obtained from the decoder or be estimated by some function like cp; and jbm_Comp_{woTS}(i) is the estimation of complexity of jitter buffer management that could include all or only some of pitch determination, time scaling, adaptation logic, buffering, network analysis. It could be a constant or a function which depends on sampling rate, bitrate, delay mode, etc., like cp.

Then:

$$producedNumberOfSamples ( i ) \geq ( {dec\_Comp}_{woTS} ( i ) + {jbm\_Comp}_{woTS} ( i ) ) * \frac{normalNumberOfSamples ( i )}{cp}$$

3. If the time scaling is going to reduce the number of samples, the number of samples to be reduced is:

$$deltaNumberOfSamples ( i ) = normalNumberOfSamples ( i ) - producedNumberOfSamples ( i ) \leq ( 1 - \frac{{dec\_Comp}_{woTS} ( i ) + {jbm\_Comp}_{woTS} ( i )}{cp} ) * normalNumberOfSamples ( i )$$

4. If the maximum reduced number of samples

$$max ( deltaNumberOfSamples ( i ) ) = ( 1 - \frac{{dec\_Comp}_{woTS} ( i ) + {jbm\_Comp}_{woTS} ( i )}{cp} ) * normalNumberOfSamples ( i ) \leq min\_pitch$$

where min_pitch is the value of minimum pitch, then the number of samples will not be reduced. Else the number of samples will be reduced and go to step 5. If the pitch information pitch_inf could be obtained in the decoder, for example the codec is based on CELP, ACELP, LPC or other technologies which have pitch information included in the encoded data, then

An alternative of step 4 could be:

If the maximum reduced number of samples

$$max ( deltaNumberOfSamples ( i ) ) = ( 1 - \frac{{dec\_Comp}_{woTS} ( i ) + {jbm\_Comp}_{woTS} ( i )}{cp} ) * normalNumberOfSamples ( i ) \leq max ( min\_pitch , pitch\_inf - pitch\_d )$$

where pitch_d is a small distance, for example pitch_d=1, 2 or 3, then the number of samples will not be reduced. Else the number of samples will be reduced and go to step 5.

5. If step 4 decides that the number of samples will be reduced, a limit of max(deltaNumberOfSamples(i)) will be used for pitch determination as the upper limit of the pitch. However, there are a lot of methods for determining the pitch known in literature, most of them are based on correlation analysis.

6. Time scaling will be conducted according to the pitch determination result of step 5.

However, there are a lot of time scaling methods known in literature, which normally include windowing, overlap-and-add.

Further it could be possible that some external information related to the complexity, for example battery life information or the number of channels in a media control unit—MCU, will be fed to adaptation control logic to do the complexity evaluation.

FIG. 12 shows a jitter buffer management based on complexity evaluation and an external control parameter. The jitter buffer management implementation includes a media adaptation unit 1201, an adaptation control logic 1203, a network analysis 1205, a jitter buffer 1211, a decoder 1213.

One example is like the aforementioned, where the only difference is in step 1, in which an external control parameter N is the number of channels for a MCU device and then cp=cp_const/N

Another example is like the aforementioned, where the only difference is in step 1, in which an external control parameter 0≦bl≦1 reflects the battery life of the device and then cp=cp_const·bl.

Another example is like the aforementioned, where the only difference is in step 1, in which there are two external control parameters bl and N and then cp=cp_const·bl/N.

What is claimed is:

1. A voice or audio signal processor for processing received network packets received over a communication network to provide an output signal, the voice or audio signal processor comprising:
a jitter buffer configured to buffer the received network packets;
a voice or audio decoder configured to decode the received network packets buffered by the jitter buffer to obtain a decoded voice or audio signal;
a controllable time scaler configured to amend a length of the decoded voice or audio signal to obtain a time scaled voice or audio signal as the output voice or audio signal; and
an adaptation control means configured to control an operation of the time scaler in dependency on a processing complexity measure.

2. The voice or audio signal processor of claim 1, wherein the adaptation control means is configured to transmit a time scaling request indicating to amend the length of the decoded voice or audio signal in dependency on the processing complexity measure in order to control the controllable time scaler.

3. The voice or audio signal processor of claim 1, wherein the adaptation control means is configured to determine a number of samples by which to amend the length of the decoded voice or audio signal upon the basis of the processing complexity measure, and to transmit a time scaling request to the controllable time scaler, and wherein the controllable time scaler is configured to amend the length of the decoded voice or audio signal by the determined number of samples.

4. The voice or audio signal processor of claim 1, wherein the processing complexity measure is determined by at least one of: complexity of decoding, a length of the time scaled voice or audio signal frame, bitrate, sampling rate or delay mode.

5. The voice or audio signal processor of claim 1, further comprising storage for storing different processing complexity measures for different decoded voice or audio signal lengths.

6. The voice or audio signal processor of claim 1, wherein the voice or audio decoder is configured to provide the processing complexity measure to the adaptation control means.

7. The voice or audio signal processor of claim 1, wherein the adaptation control means is further configured to control the operation of the controllable time scaler in dependency on a jitter buffer status.

8. The voice or audio signal processor of claim 7, wherein the jitter buffer is configured to provide the jitter buffer status to the adaptation control means.

9. The voice or audio signal processor of claim 1, wherein the adaptation control means is further configured to control the operation of the controllable time scaler in dependency on a network packet arrival rate.

10. The voice or audio signal processor of claim 1, further comprising a network arrival rate determiner for determining a packet arrival rate of the network packets, and to provide the packet rate to the adaptation control means.

11. The voice or audio signal processor of claim 1, wherein the controllable time scaler is configured to amend the length of the decoded voice or audio signal by a number of samples.

12. The voice or audio signal processor of claim 1, wherein the controllable time scaler is configured to overlap and add portions of the decoded voice or audio signal for time scaling.

13. The voice or audio signal processor of claim 1, wherein the controllable time scaler is configured to provide a time scaling feedback to the adaptation control means, the time scaling feedback informing the adaptation control means of the length of the time scaled voice or audio signal.

14. A method for processing received network packets over a communication network to provide an output signal, the method comprising:
buffering the received network packets;
decoding the buffered network packets to obtain a decoded voice or audio signal;
controllably amending a length of the decoded voice or audio signal to obtain a time scaled voice or audio signal as the output voice or audio signal in dependency on a processing complexity measure.

15. A computer program for performing the method of claim 14 when run on a computer.
